(19) United States
(12) Patent Application Publication
(10) Pub. No.: US 2021/0379517 A1
(43) Pub. Date: Dec. 9, 2021

(54) LIQUID HYDROCARBON FILTERABILITY SYSTEM

(71) Applicant: DONALDSON COMPANY, INC., Minneapolis, MN (US)

(72) Inventors: Matthew Goertz, Bloomington, MN (US); Davis B. Moravec, Burnsville, MN (US); Andrew J. Dallas, Lakeville, MN (US); Scott A. Grossbauer, Bloomington, MN (US); Bradly G. Hauser, Minneapolis, MN (US); James N. Doyle, Bloomington, MN (US); Daniel L. Tuma, St. Paul, MN (US); Matthew T. Matsumoto, Pasadena, CA (US); Kelly C. Robertson, Rosemount, MN (US)

(21) Appl. No.: 17/405,665

(22) Filed: Aug. 18, 2021

Related U.S. Application Data
(62) Division of application No. 16/063,027, filed on Jun. 15, 2018.
(60) Provisional application No. 62/267,681, filed on Dec. 15, 2015.

(51) Int. Cl. B01D 39/00; B01D 37/04

(52) U.S. Cl. CPC B01D 39/00; B01D 37/043; B01D 37/046; B01D 2279/60; B01D 2257/702; B01D 2275/30; B01D 2239/1216

(57) ABSTRACT

A liquid hydrocarbon filterability system includes a liquid hydrocarbon sample source piping in fluid communication with a liquid hydrocarbon sample container. A filtration media element is in fluid communication with the liquid hydrocarbon sample source piping. Filtered liquid hydrocarbon outlet piping is in fluid communication with and downstream of the filtration media element. A flow or volume measurement element is in fluid communication with the filtered liquid hydrocarbon outlet piping and is configured to measure an amount of liquid hydrocarbon passing through the filtration media element. A constant pressure source is configured to provide liquid hydrocarbon to the filtration media element at a constant pressure.

The disclosure herein relates to liquid hydrocarbon filterability systems and methods. In particular the disclosure relates to a robust, high resolution, on-demand or portable systems and methods of determining liquid hydrocarbon filterability.

One standard test method for determining fuel contaminate level is to pass a volume of fuel through a pre-weighed filter, dry the filter and determine the mass of the particulate trapped by the filter. The change in mass defines the amount of particulate in the fuel sample.

Another standard test method for determining fuel filterability or filter blocking tendency is to pass a temperature controlled, constant flow of fuel sample through a filter element and measure the pressure increase on the upstream side of the filter element.

The standard fuel filterability test methods dictate specific sensitive testing equipment maintaining specific testing temperatures and other conditions. The standard fuel filterability test methods tend to be low resolution tests.

### SUMMARY

The present disclosure relates to liquid hydrocarbon filterability systems and methods. In particular the disclosure relates to robust, high resolution, on-demand or portable systems and methods of determining liquid hydrocarbon filterability.

In one aspect, a liquid hydrocarbon or fuel filterability system includes a liquid hydrocarbon (or fuel) sample source piping in fluid communication with a liquid hydrocarbon (or fuel) sample container. A filtration media element includes filtration media. The filtration media element is in fluid communication with the liquid hydrocarbon (or fuel) sample source piping. Filtered liquid hydrocarbon (or fuel) outlet piping is in fluid communication with and downstream of the filtration media element. A flow or volume measurement element is in fluid communication with the filtered liquid hydrocarbon (or fuel) outlet piping and is configured to measure an amount of liquid hydrocarbon (or fuel) passing through the filtration media element. A constant pressure source is configured to provide liquid hydrocarbon (or fuel) to the filtration media element at a constant pressure.

In another aspect, a method includes applying a constant pressure to a fuel sample to form a pressurized fuel sample and then flowing the pressurized fuel sample through filtration media at the constant pressure to form a filtered sample amount. The filtered sample is then measured to determine fuel filterability.

In a further aspect, a kit includes a fuel sample container having a volume of about 0.5 liter or greater or 0.75 liter or greater or 1 liter or greater and a constant pressure source inlet coupled to the fuel sample container. The constant pressure source inlet is configured to apply a constant pressure that is greater than atmospheric pressure. Fuel outlet piping is coupled to the fuel sample container. The kit includes a plurality of filtration media elements. Each filtration media element is configured to be coupled to and released from an end of the fuel outlet piping within the fuel sample container. Each filtration media element may be configured to retain filtration media having a filtration surface area of about 1.5 cm² or less. A fuel outlet container is in fluid connection with the fuel outlet piping and configured to measure an amount of fuel passing through the filtration media element.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1A is a schematic flow diagram of an exemplary system for determining hydrocarbon fluid filterability.

FIG. 1B is a schematic flow diagram of another exemplary system for determining hydrocarbon fluid filterability.

FIG. 2 is a schematic diagram of another exemplary system for determining hydrocarbon fluid filterability.

FIG. 3 is a graph of volume versus time for three levels of fuel contaminate.

FIG. 4 is a graph of time versus volume for three levels of fuel contaminate.

### DETAILED DESCRIPTION

The present disclosure relates to liquid hydrocarbon fluid filterability systems and methods. In particular the disclosure relates to a robust, high resolution, on-demand or portable system and method of determining liquid hydrocarbon fluid, preferably fuel, filterability. This system and method utilizes a constant pressure of sample liquid applied to the filtration media. The flowrate decay may be utilized to easily determine the contamination level in the sample liquid.

The hydrocarbon fluid filterability system and method may be a portable system that provides reliable and high resolution test results that may indicate hydrocarbon contaminate level and may also provide a life expectancy of a correlated liquid hydrocarbon or fuel filter. A constant pressure source provides the liquid hydrocarbon (or fuel) sample to the filtration media at a constant pressure, preferably in a range from 207 kPa (30 psig) to 415 kPa (60 psig) or from 241 kPa (35 psig) to 415 kPa (60 psig) or from 275 kPa (40 psig) to 415 kPa (60 psig). The constant pressure source may provide the liquid hydrocarbon (or fuel) sample to the filtration media at a constant pressure that is greater than 415 kPa (60 psig), or in a range from 275 kPa (40 psig) to 550 kPa (80 psig). The liquid hydrocarbon (or fuel) sample passes through the filtration media and forms a filtered sample amount. This filtered sample amount may be measured as a function of time to determine the contaminate level or fuel filterability of the liquid hydrocarbon (or fuel) sample. The decay in flow rate (mass or volume) may identify contaminate level and may also be used to estimate the lifetime of an associated filter that is filtering a liquid hydrocarbon material (or fuel) where the sample was sourced from. The testing filtration media has a filtration area that is small enough to provide contaminate level sensitivity (or resolution) that has not been previously described. The testing filtration media may have a filtration area of 1.5 cm² or less and a maximum pore size of 10 micrometers or less. The hydrocarbon filterability system and method also utilizes a large volume of hydrocarbon sample. The hydrocarbon filterability system and method may utilize 0.5 liter or greater, or 0.75 liter or greater, or 1 liter or greater, of hydrocarbon sample. Thus the hydrocarbon filterability system and method may filter at least 0.5 linear meters, or at least 0.75 meters, or at least 1 linear meter of liquid hydrocarbon or fuel. The filtration media may be contained within a filtration media element that may be replaced easily with a clean filtration media element. The filtration media elements may be tailored to remove different sizes of particulate matter or different contaminants found within hydrocarbon. Filtration media elements may be tailored to mimic specific full sized filter elements (on tank or on vehicle) to simulate a filtration process. While the present disclosure is not so limited, an appreciation of various aspects of the disclosure will be gained through a discussion of the embodiments provided below.

In the preceding description, reference is made to the accompanying set of drawings that form a part hereof and in which are shown by way of illustration several specific embodiments. It is to be understood that other embodiments are contemplated and may be made without departing from (e.g., still falling within) the scope or spirit of the present disclosure. The preceding detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that may vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

It is noted that terms such as “top”, “bottom”, “above, “below”, etc. may be used in this disclosure. These terms should not be construed as limiting the position or orientation of a structure, but should be used as providing spatial relationship between the structures.

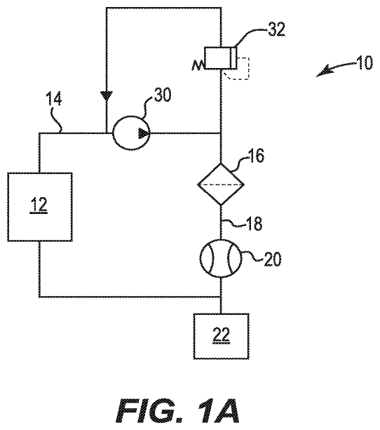

FIGS. 1A and 1B are schematic flow diagrams of exemplary systems 10 for determining liquid hydrocarbon (or fuel) filterability. The liquid hydrocarbon (or fuel) filterability system 10 includes a liquid hydrocarbon (or fuel) sample source piping 14 in fluid communication with a liquid hydrocarbon (or fuel) sample container 12. A filtration media element 16 includes filtration media. The filtration media element 16 is in fluid communication with the liquid hydrocarbon (or fuel) sample source piping 14. Filtered liquid hydrocarbon (or fuel) outlet piping 18 is in fluid communication with and downstream of the filtration media element 16. A flow or volume measurement element 20 is in fluid communication with the filtered liquid hydrocarbon (or fuel) outlet piping 18 and is configured to measure an amount of liquid hydrocarbon (or fuel) passing through the filtration media element 16. A constant pressure source 30 is configured to provide liquid hydrocarbon (or fuel) to the filtration media element 16 at a constant pressure.

The constant pressure source 30 may be any element that applies a pressure to the sample liquid hydrocarbon (or fuel) flowing to the filtration media element 16. The constant pressure source 30 may be a fluid pump, such as a positive displacement pump, for example. The constant pressure source 30 may be a compressed gas, such as an inert gas, for example.

The constant pressure source 30 may be a positive displacement pump that may change flow rates in response to a pressure sensor downstream of the positive displacement pump. The constant pressure source 30 may be a positive displacement pump operating at a constant flow rate and coupled to a pressure value 32 that relieves pressure to maintain a constant pressure contacting the filtration media element 16. The pressure value 32 may be in fluid connection and between the constant pressure source 30 and the filtration media element 16. The pressure valve 32 may relieve pressure back upstream of the positive displacement pump 30 or downstream from the flow or volume measurement element 20 to another container downstream such as the filtered sample container 22 or to piping downstream from the flow or volume measurement element 20, for example.

The flow measurement element 20 is configured to measure and provide a flow rate measurement value. The volume measurement element 20 is configured to measure and provide a volume measurement value.

The constant pressure source 30 forms a pressurized liquid hydrocarbon or fuel sample that is then passed though the filtration media 16 at the constant pressure, upstream of the filtration media 16, to form a filtered sample. The filtered sample is then measured (mass or volume) as a function of time to determine the contaminate level or filterability of the liquid hydrocarbon sample.

The filtered sample amount may then be removed from the system or returned to the hydrocarbon sample container 12. The hydrocarbon sample container 12 may be a hydrocarbon storage container or transport container. A filtered sample container 22 may collect the filtered sample and then be removed from the system.

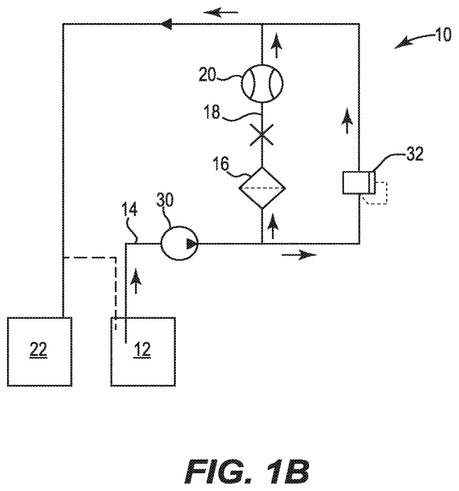

FIG. 2 is a schematic diagram of one exemplary system 100 for determining liquid hydrocarbon or fuel filterability. A liquid hydrocarbon (or fuel) filterability system 100 includes a liquid hydrocarbon (or fuel) sample container 110 and a constant pressure source 120 coupled to the liquid hydrocarbon (or fuel) sample container 110. Filtered liquid hydrocarbon (or fuel) outlet piping 140 is coupled to the liquid hydrocarbon (or fuel) sample container 110 and a filtration media element 130 is disposed within the hydrocarbon sample container 110 and in fluid connection with the filtered liquid hydrocarbon (or fuel) outlet piping 140. The filtration media element 130 is configured to retain filtration media. A liquid hydrocarbon (or fuel) outlet container 150 is in fluid connection with the filtered liquid hydrocarbon (or fuel) outlet piping 140 and configured to measure an amount of liquid hydrocarbon (or fuel) passing through the filtration media element 130. The liquid hydrocarbon (or fuel) outlet container 150 may be replaced with a flow or volume measurement element described above.

The constant pressure source is configured to apply a constant pressure to the liquid hydrocarbon (or fuel) sample within the container. The liquid hydrocarbon (or fuel) sample container may include a lid element 105 that will withstand the pressure applied by the constant pressure source 120. In some of these embodiments the constant pressure source 120 is a sealed compressed gas container such as a cartridge, bottle or cylinder. The constant pressure source 120 may be pressurized liquid hydrocarbon (or fuel) sample provided as described above.

The liquid hydrocarbon (or fuel) sample container 110 has a substantial sample volume that may be tunable to a specific application or simulation. The liquid hydrocarbon (or fuel) sample container 110 may have a volume of about 0.5 liter or greater or about 0.75 liter or greater or about one liter or greater. The liquid hydrocarbon (or fuel) sample may be less than 10 liters, for example. This substantial volume may assist in simulating large scale filtration unit operations. The substantial volume also reduces the risk of trace external contaminates from causing variability in the sample testing.

The filtration media element 130 may be submerged within the liquid hydrocarbon (or fuel) sample volume. Having the filtration media 130 element submerged or immersed within the liquid hydrocarbon (or fuel) sample volume for a time period before liquid hydrocarbon (or fuel) is collected at the liquid hydrocarbon (or fuel) outlet container 150 may provide a number of advantages. For example, the filtration media element 130 and filtration media temperature may equilibrate with the temperature of the liquid hydrocarbon (or fuel) sample volume and the filtration media element 130 and filtration media will have the head pressure of the liquid hydrocarbon (or fuel) sample volume already applied prior to application of the constant pressure source. Having the filtration element and filtration media within the sample volume may also reduce or eliminate contamination of the piping and process elements downstream of the filtration media.

The filtration media element 130 is in fluid connection with the filtered liquid hydrocarbon (or fuel) outlet piping 140. The filtration media element 130 may be fixed to an upstream-most end of the filtered liquid hydrocarbon (or fuel) outlet piping 140. Thus, contaminates are filtered or captured by the filtration media retained within the filtration media element 130 and do not end up in the filtered liquid hydrocarbon (or fuel) outlet piping 140 or elements downstream of the filtration media. Thus the volume or flow measurement element does not become fouled or need to be cleaned. This provides an advantage of not having to clean the filtered liquid hydrocarbon (or fuel) outlet piping 140 or reduced time or effort to clean the filtered liquid hydrocarbon (or fuel) outlet piping 140 or the volume or flow measurement element between sample tests. Having the filtration media as the most upstream component of the filtered liquid hydrocarbon (or fuel) outlet piping ensures that the filtration media is the first outlet element that the test sample contacts.

The filtration media may be contained or retained within the filtration media element 130. The filtration media element 130 may be a rigid housing that holds or retains a layer of filtration media. The filtration media element 130 may be a polymeric element or a metallic element. The filtration media element 130 may be configured to retain an outer portion or periphery of the filtration media and allow sample filtration fluid to pass through a central portion of the filtration media.

The filtration media element 130 may be replaced easily with a clean filtration media element on the fuel outlet piping 140. The filtration media element 130 may have a male or female threaded portion to screw onto the fuel outlet piping 140. The filtration media element 130 may have a detent or snap-fit portion to snap onto the fuel outlet piping 140. The filtration media element 130 may be configured to replace the filtration media retained within the filtration media element 130.

The filtration media may be the same media used in vehicle fuel filters. In one case the media is available under the commercial designation Synteq XP® and may be described in U.S. Pat. No. 7,314,497 B2. The media is held in a molded cartridge that may allow for easier handling than a traditional filter media disks. The filtration media element may be open on top to allow ease of viewing of the collected contaminate. This may also provide for a visual confirmation of the contamination levels.

The filtration media element may have any useful dimensions. In many embodiments, the filtration media element may have a diameter of 3 cm or less, or 2 cm or less, or in a range from 1 to 3 cm, or from 1 to 2 cm. In many embodiments, the filtration media element may have a height of or 3 cm or less, or 2 cm or less, or in a range from 1 to 3 cm or from 1 to 2 cm.

The filtration media has a reduced filtration area as compared to other test methods. The filtration media may have a filtration surface area of about 1.5 cm² or less, or about 1 cm² or less or in a range from 0.2 to 1.5 cm² or in a range from 0.2 to 1 cm². Reducing the filtration surface area may increase the sensitivity or resolution of the filtration test measurement since the sample volumes are relatively large, as described herein.

The filtration media may be any useful filtration material for hydrocarbon material. The filtration media may have a maximum pore size of about 10 micrometers or less, or 5 micrometers or less, or 3 micrometer or less, or in a range from 0.4 to 10 micrometers or from 0.4 to 5 micrometers. A maximum pore size rating may describes the largest pore accessible to flow through a filter media as tested by the method described in ASTM F 316.

The filtration media elements may be tailored to contain or retain filtration media that removes different sizes of particulate matter or different contaminants found within hydrocarbon material. Filtration media retained within the filtration media elements may be tailored to mimic specific full sized filter elements to simulate a filtration process. The filtration media retained within the filtration media elements may be the same kind or type of filtration media. Using the same kind or type of may allow a user to simulate and predict the actual lifetime of the on-vehicle or full size filter filtering the fuel that was sampled.

The systems and methods described herein provides for the linear amount of liquid hydrocarbon or fuel passing through the filtration surface area that is greater than other liquid hydrocarbon or fuel testing methods. For example, the systems and methods described herein provide for at least 0.5, at least 0.75, or at least 1 linear meter of liquid hydrocarbon or fuel to pass through the filtration element. Prior fuel filterability tests utilize less than 0.2 linear meters of fuel. Increasing the linear amount of fuel tested improves the resolution of the fuel filterability test.

For comparison, commercial or “on-vehicle” fuel filters may be designed to filter a determined linear amount of hydrocarbon sample through the filtration surface area and may be dependent on the level of contaminate in the hydrocarbon sample. For relatively dirty fuel, the linear amount of fuel passing through the commercial filter filtration surface area may only be 4 meters or less or 3 meters or less, or in a range from 0.5 to 4 meters. A typical on-engine fuel filter is designed to filter about 20 to 40 linear meters of fuel (clean fuel), for example.

A fuel outlet container or the flow or volume measurement element is configured to measure the amount of liquid hydrocarbon (or fuel) passing through the filtration media. The fuel outlet container may measure the actual volume or weight of the liquid hydrocarbon (or fuel) passing through the filtration media. The flow or volume measurement elements may be on-line volume or flow meters that measure the volume or flow rate of the liquid hydrocarbon (or fuel) passing through the filtration media. Two or more, or continuous measurements may be taken to determine the hydrocarbon or fuel filterability.

The fuel outlet container may include two or more defined volumes and may be contained within a single container or vessel or the two or more defined volumes may be contained in separate and distinct containers or vessels. In this instance, outlet flow can enter the first measuring container volume for a specified time interval and then be diverted to a second measuring container volume for a specified time interval. In many embodiments, the time interval value is the same. Here the amount (volume, mass or flow rate) can be compared to determine the decay in flow rate (over two or more time intervals) and thus, the filterability of the hydrocarbon sample.

The fuel outlet container may include two or more defined volumes and may be contained within a single container or vessel or the two or more defined volumes may be contained in separate and distinct containers or vessels. In this instance, outlet flow can enter the first measuring container volume until the first volume is reached and then be diverted to a second measuring container volume until the second volume is reached. In some embodiments, the defined volumes are the same. Here the time to fill each volume can be compared to determine the decay in flow rate (over the two or more volume intervals) and thus, the filterability of the hydrocarbon sample.

The flow measurement element, or flow meter can continuously output the flow rate passing through the filtration element. A curve of flow rate as a function of time or volume may be formed to illustrate the flow rate decay.

The liquid hydrocarbon to be filtered may be any filterable liquid hydrocarbon material. The liquid hydrocarbon may be oil. Preferably the liquid hydrocarbon is a fuel, such as diesel fuel for example. The liquid hydrocarbon or fuel may have a viscosity of 10 cP or less or from 1 to 10 cP, or from 1 to 5 cP. This low viscosity liquid hydrocarbon or fuel is provided to the reduced area filtration element at a constant pressure in a range from about 207 kPa (30 psig) to 415 kPa (60 psig), or from 241 kPa (35 psig) to 415 kPa (60 psig), or from 275 kPa (40 psig) to 415 kPa (60 psig), or greater. High resolution results may be obtained by filtering at least 0.5 linear meters of this low viscosity fuel through a reduced surface area filter element at these high constant pressure values.

Determining contaminate levels in fuels such as diesel fuel is often difficult. Current standards require the use of sensitive, expensive and bulky equipment. In addition, the contaminate size that is tested with these ASTM methods are quite large. It has been found that even moving fuel causes contaminate levels to increase. Three currently used methods for determining the cleanliness and filterability of diesel fuels include: ASTM D2068, D6217, and D1796.

The first of these methods, ASTM D2068 “Standard Test Method for Determining Filter Blocking Tendency” involved passing a maximum of 300 ml of diesel fuel through a 1.3 cm² patch at a constant flow rate. Either the pressure measured at 300 ml filter fluid or volume filtered at 105 kPa of differential pressure is used to calculate the filter blocking tendency. The filter blocking tendency number is then related by the fuel user to estimate a prediction of filter life. In this method the linear amount of fluid filtered is less than 0.2 meters.

The second of these methods, ASTM D6217 “Standard Test Method for Particulate Contamination in Middle Distillate Fuels by Laboratory Filtration”, involves filtering 1 liter of fuel through a 47 millimeter diameter filter membrane with 0.8 micrometer pores. The amount of contaminant is then gravimetrically determined and reported in a range of 0-25 mg/l to the nearest 0.1 mg/l.

The third of method, ASTM D2709 “Standard Test Method for Water and Sediment in Middle Distillate Fuels by Centrifuge” involves centrifuging 100 ml of fuel and visually recording the volume of contaminant to the nearest 0.005 ml. If all of the contaminant was a dust of density 2 grams per cubic centimeter, the detection limit of the technique is a contamination level of 10 milligrams per 1 liter.

Modern high pressure fuel systems are sensitive to fine particulate in a range of 2 to 4 micrometers. Filters for these high pressure fuel systems need to remove nearly all of it to protect them. This fine particulate is typically about 85% of the particulate load in number (not mass) in fuel. In fuels with short filter life/filterability issues the concentration of this very fine particulate can be much higher and plug things very quickly leading to unexpected downtime and maintenance. The liquid hydrocarbon (or fuel) filterability systems and methods described herein provide an increased sensitivity (or resolution) to determine filterability of liquid hydrocarbon (or fuel) that contain fine contaminate particles.

The exemplary system for determining fuel filterability may be utilized by applying a constant pressure to a liquid hydrocarbon (or fuel) sample and flowing the pressurized liquid hydrocarbon (or fuel) sample through filtration media and into fuel outlet piping to form a filtered sample amount. Then the method includes measuring the filtered sample amount (as a function of time) and determining fuel filterability based on the measuring step.

The measuring step may include measuring the filtered sample amount at a first time and a second time. The measuring step may include measuring the filtered sample amount continuously for a specified time period or until the sample stops flowing. The measuring step may include measuring a flow rate of the filtered sample as a function of time.

The measuring step may include measuring a decay of a flow rate of the filtered sample amount by measuring three or more filtered sample amounts at specified times. The measuring step may include measuring a decay of a flow rate of the filtered sample amount continuously for a specified time period or until the sample stops flowing. The measuring step may include measuring the time for a first volume and a time for a second volume.

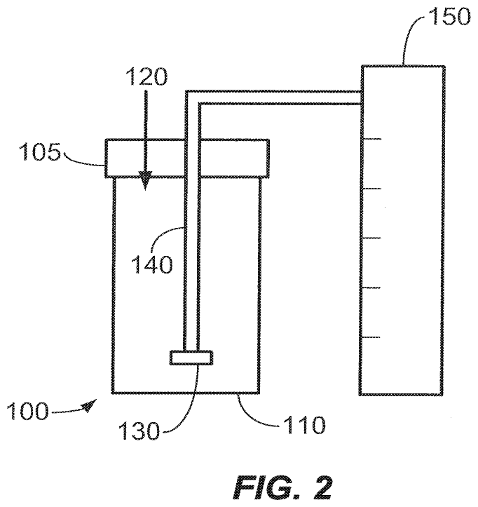

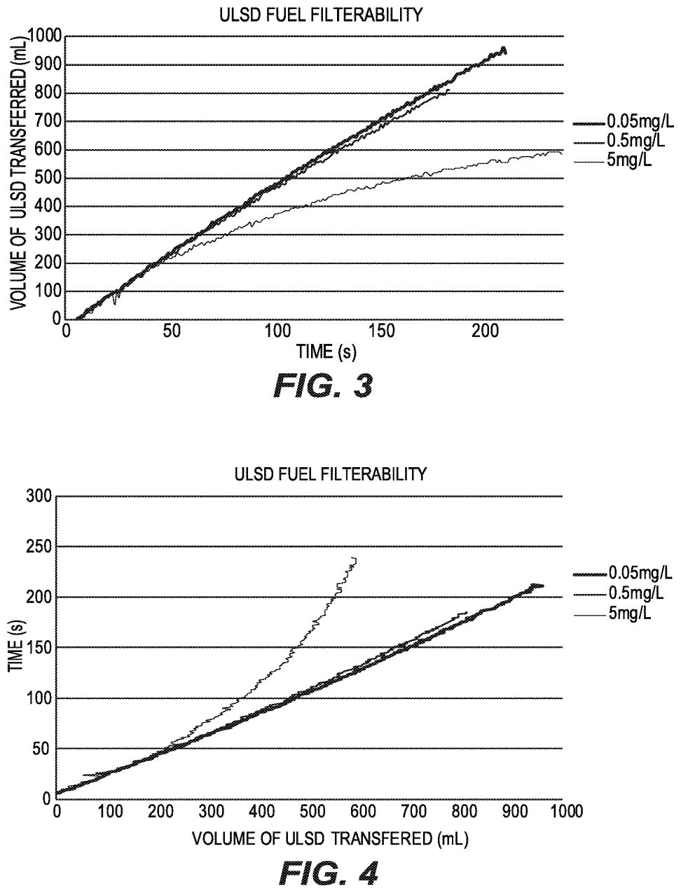

To account for some inherit forms of sample and testing variability (e.g. fluid viscosity, variability in media sample) it may be preferable to measure the time as a function of volume transferred (FIG. 4) as opposed to the volume transferred as a function of time (FIG. 3). The data could be fit to a function that can provide the time required to reach two different volumes:

t=f(V)−(V₁,t_{V1})&(V₂,t_{V2})

This can be used to determine a filterability value:

$$f = ( \frac{\text{?} - \text{?}}{\text{?}} ) / ( \frac{{V}_{2} - {V}_{1}}{{V}_{1}} )$$

$$\text{?} \text{indicates text missing or illegible when filed}$$

Where t_{V1} and t_{V2} are the times to reach the first volume (V₁) and second volume (V₂) respectively. In the experiment the first volume is reached before the second volume. The same V₁ and V₂ must be used when comparing two separate fluids. In some samples with higher contamination levels the second volume may be determined from extrapolating the data fit to a volume that was not reached during the experiment. One example would be to use a first volume of 250 ml and a second volume of 1000 ml. In this case the data was fit to a second order polynomial to yield A, B and C coefficients. This is showing in Table 1:

TABLE 1
F Values of Various Iso-Dust Concentrations using Curve Fit and
Volumes

| Fuel Mixture | | | | | | |
|---|---|---|---|---|---|---|
| Iso-Medium | 2nd Order Curve Fit | | | V1 | V2 | |
| Dust mg/l | A | B | C | 250 | 1000 | F value |
| 0.05 | 3.29E−05 | 1.85E−01 | 3.81E+00 | 48 | 218 | 1.170268 |
| 0.5 | 4.12E−05 | 1.88E−01 | 3.30E+00 | 50 | 229 | 1.207766 |
| 5 | 5.45E−04 | 3.25E−02 | 1.22E+01 | 42 | 578 | 4.22963 |

Similarly, the function of time vs volume can be used to calculate a slope at one volume (V₁) and a second volume (V₂). Then filterability value could be calculated as follows:

$$f = ( \frac{\text{?}}{\text{?}} )$$

$$\text{?} \text{indicates text missing or illegible when filed}$$

Where s_{V1} and s_{V2} are the slopes of the function at the first volume (V₁) and second volume (V₂) respectively.

An example of this is shown in Table 2:

TABLE 2
F values of Various Iso-Dust Concentrations Using Curve Fit and
Slopes

| Fuel Mixture | | | | | | |
|---|---|---|---|---|---|---|
| Iso-Medium | 2nd Order Curve Fit | | | Slope V1 | Slope V2 | |
| Dust mg/1 | A | B | C | 200 | 1000 | F value |
| 0.05 | 3.29E−05 | 1.85E−01 | 3.81E+00 | 0.1982 | 0.2508 | 1.265644 |
| 0.5 | 4.12E−05 | 1.88E−01 | 3.30E+00 | 0.2045 | 0.2704 | 1.322379 |
| 5 | 5.45E−04 | 3.25E−02 | 1.22E+01 | 0.2505 | 1.1225 | 4.481038 |

In both cases a value of 1 (for F value) indicates that the flow rate did not decrease during the test and is an indication of a clean fuel. Values greater than 1 indicate that the fluid had some level of contaminant. Dirtier fluids will cause a larger decrease in flowrate under constant pressure and will return larger filterability values.

The determining step may define or estimate a number of expected service hours for a fuel filter element comprising fuel filtration media filtering fuel that is representative of the fuel sample, and the fuel filtration media corresponds to the filtration media. Utilizing the systems and methods described herein, it has been found that this system may simulate a full size bulk filtration unit operation where the filter element has a filtration surface area of 0.5 m² or greater, or 0.7 m² or greater or 1 m² or greater. This system filtration media may simulate a typical on-vehicle filtration unit operation where the filter element has a filtration surface area in a range from 0.05 to 0.15 m², or 0.08 to 0.12 m² or about 0.1 m².

The determining step may define or determine a contaminate concentration in the fuel sample. This determining step may be independent of a temperature of the fuel sample.

### Examples

FIG. 3 is a graph of volume versus time for three levels of fuel contaminate. FIG. 4 is a graph of time versus volume for three levels of fuel contaminate and an associate polynomial curve fit.

Diesel fuel meeting ASTM D975 was sourced from a local vendor and pre-filtered through a 0.45 μm membrane (Product #60173, Pall Life Sciences) before using. Pre-filtration was performed to eliminate stray sources of unwanted fuel contamination. For each series of tests a set of fuels was prepared with varying amount of contaminant using serial dilutions from the most concentrated sample. This procedure helps to reduce variation within a single set of tests. The contaminant used in these experiments was ISO 12103-1, A3 Medium Test dust from Powder Technology Inc. (Burnsville, Minn.)

For each test, the sample fluid was loaded into a vessel and the headspace pressurized using a compressed gas source. Once pressured the experiment starts by allowing fluid to access the filter media. The headspace pressure is held constant at 50 PSI for the entirety of the test through a 1 stage pressure regulator. The fluid volumetric flow rate or total volume filtered is measured using a flow meter or level sensor, respectively. If the fluid flow rate is measured, the volume of fluid filtered at any specific time if found through integration of a flow rate versus time function. In the experiments shown in FIG. 3 the unlabeled solid line curves used a level sensor to measure total volume filtered and “Run 2” dashed line curves used a flow meter to measure volumetric flow rate. FIG. 4 is a graph of this data but illustrated as time versus volume for the three levels of fuel contaminate and an associate polynomial curve fit for each of the three fuel contaminate levels.

Embodiments of the systems, methods and kits to determine fuel filterability are disclosed. The implementations described above and other implementations are within the scope of the following claims. One skilled in the art will appreciate that the present disclosure may be practiced with embodiments other than those disclosed. The disclosed embodiments are presented for purposes of illustration and not limitation, and the present invention is limited only by the claims that follow.

1-10. (canceled)

11. A method of determining fuel filterability, comprising:
applying a constant pressure in a range from 207 kPa (30 psig) to 415 kPa (60 psig) to a fuel sample to form a pressurized fuel sample;
flowing the pressurized fuel sample through filtration media at the constant pressure to form a filtered sample amount;
measuring the filtered sample amount; and
determining fuel filterability based on the measuring step.

12. The method according to claim 11, wherein the measuring step comprises measuring the filtered sample amount at a first time interval and a second time interval.

13. The method according to claim 11, wherein the measuring step comprises measuring a decay of a flow rate of the filtered sample amount by measuring three or more filtered sample amounts at specified times.

14. The method according to claim 11, wherein the measuring step comprises measuring a first volume for a first time interval and then measuring a second volume for a second time interval.

15. The method according to claim 11, wherein the flowing step comprises flowing at least 0.5 linear meters of fuel through the filtration media.

16. The method according to claim 11, wherein the filtration media has a filtration surface area of about 1.5 cm² or less and the fuel sample defines a volume of at least about 0.5 liter.

17. (canceled)

18. The method according to claim 11, wherein determining the fuel filterability comprises defining a number of expected service hours for a fuel filter element.

19. The method according to claim 11, wherein determining the fuel filterability comprises determining a contaminate concentration in the fuel sample independent of a temperature of the fuel sample.

20. The method according to claim 11, wherein the fuel sample is diesel fuel.

21. The method according to claim 11, wherein the fuel sample has a viscosity of 10 cP or less.

22. A method of determining fuel filterability, comprising:
submerging a filtration media element within a fuel sample volume;
equilibrating temperatures of the filtration media element and the fuel sample volume;
applying a constant pressure in a range from 207 kPa (30 psig) to 415 kPa (60 psig) with a sealed container of compressed inert gas to the fuel sample to form a pressurized fuel sample;
flowing the pressurized fuel sample through filtration media at the constant pressure to form a filtered sample amount;
measuring the filtered sample amount; and
determining fuel filterability based on the measuring step.

23. The method according to claim 22, wherein the measuring step comprises measuring the filtered sample amount at a first time interval and a second time interval.

24. The method according to claim 22, wherein the measuring step comprises measuring a decay of a flow rate of the filtered sample amount by measuring three or more filtered sample amounts at specified times.

25. The method according to claim 22, wherein the measuring step comprises measuring a first volume for a first time interval and then measuring a second volume for a second time interval.

26. The method according to claim 22, wherein the flowing step comprises flowing at least 0.5 linear meters of fuel through the filtration media.

27. The method according to claim 22, wherein the filtration media has a filtration surface area of about 1.5 cm² or less and the fuel sample defines a volume of at least about 0.5 liter.

28. The method according to claim 22, wherein determining the fuel filterability comprises defining a number of expected service hours for a fuel filter element.

29. The method according to claim 22, wherein determining the fuel filterability comprises determining a contaminate concentration in the fuel sample independent of a temperature of the fuel sample.

30. The method according to claim 22, wherein the fuel sample is diesel fuel.

31. The method according to claim 22, wherein the fuel sample has a viscosity of 10 cP or less.
